(19) United States
(12) Patent Application Publication
(10) Pub. No.: US 2024/0352267 A1
(43) Pub. Date: Oct. 24, 2024

(54) BIO-BASED SCREEN PRINTING FORMULATION FOR PROCESSING A HEAT TRANSFER

(71) Applicant: S.E.C. Accessories Limited, Hong Kong (HK)

(72) Inventors: Mimi HETTI, Hong Kong (HK); Yeuk Tin LAU, Hong Kong (HK); Jiawen HUANG, Hong Kong (HK); Ching Man CHAN, Hong Kong (HK)

(21) Appl. No.: 18/635,078

(22) Filed: Apr. 15, 2024

Related U.S. Application Data
(60) Provisional application No. 63/496,961, filed on Apr. 19, 2023.

(51) Int. Cl. C09D 11/107; B41M 5/46; C09D 11/033; C09D 11/037

(52) U.S. Cl. CPC C09D 11/107; B41M 5/465; C09D 11/033; C09D 11/037

(57) ABSTRACT

The present invention relates to a screen printing formulation a method of processing a heat transfer with the screen printing formulation for use in garment industry. The raw materials of the screen printing formulation are derived from renewable plant-based resources. It can be printed and cured by adopting current heat transfer processing technology with comparably short curing time of 0.5 hour. The cured screen printing formulation contains bio-based content as high as 93% with strength and elasticity comparable with typical TPU counterparts. The bio-based heat transfer can perform comparable performance comparing with fossil-based polyurethane and silicone heat transfer. Moreover, when applying the bio-based heat transfer on garments or fabrics, it is able to adhere firmly without peel off, cracking, shrinkage, wrinkle and color migration even after repeated laundry wash and dry, fulfilling quality standard tests of garment industry.

### CROSS-REFERENCE TO RELATED APPLICATION

The present application claims the priority from the U.S. provisional patent application Ser. No. 63/496,961 filed Apr. 19, 2023, and the disclosure of which is incorporated herein by reference in its entirety.

### FIELD OF THE INVENTION

The present invention relates to a method of preparing a screen printing formulation for processing a heat transfer and a method of processing a heat transfer with the screen printing formulation, and particularly, but not exclusively, to method of preparing a screen printing formulation from bio-based raw materials for processing a heat transfer and a method of processing a heat transfer with the screen printing formulation for use in garment industry.

### BACKGROUND OF THE INVENTION

Heat Transfer is one of the most common materials used to decorate clothes in apparel industry. It's global market size reached USD 170 billion in 2021. Heat Transfer is a kind of polymer laminate attached to a backing film and allows garments to be decorated without the use of soft inks. This involves printing an image by screen printing method with specific screen printing ink followed by curing to form a solid laminate image. The laminate image is covered with a hot melt adhesive layer so that the image is able to be transferred onto a garment or cloth rapidly using a heat press machine. Heat transfer works best for this application because it produces high-quality images with minimal deformation while being very user-friendly. The transferred image on the garment is durable without detachment and cracking even after repeated laundry wash.

Traditional screen printing ink to produce heat transfer is regarded as non-eco-friendly because it is produced from non-renewable fossil-based raw materials such as polyurethane (PU, China patent application number CN103068581B) and silicon (China patent application number CN103044925B). Due to the eco-friendly incentive of carbon reduction, the market needs of eco-friendly heat transfer material by renewable source as alternative for petroleum-based heat transfer increases and becomes an urgent concern.

Bio-based chemicals are chemicals produced from renewable bio-resources such as plant oils, sugars, starch, grains, stalks and other biomass as raw materials. The crops growing process can also help to consume carbon dioxide, which is the main kind of greenhouse gas, in certain extent. Biological fermentation technology can perform a low cost and high efficiency method to produce bio-based chemicals. With the rapid development of fermentation and processing technologies, industrial scale production of many kinds of bio-based chemicals, for example succinic acid, 2,5-furan dicarboxylic acid, 3-hydroxypropionic acid, glucaric acid, glutamic acid, itaconic acid, levulinic acid, glycerol, sorbitol and xylitol, has already been realized. Therefore, high purity bio-based chemicals are market available. China patent application number CN101450985 disclosed a polyester type biological engineering rubber which used bio-based chemicals as the building blocks to synthesize unsaturated aliphatic polyester by polycondensation. However, a peroxide type crosslinker was used and a high temperature (above 130° C.) and high pressure molded vulcanization process is required for crosslinking in order to make the elastic material. The processing conditions mentioned in CN101450985 is not applicable to heat transfer production.

Therefore, it needs to develop a more sustainable alternative of TPU heat transfer screen printing formulation by using bio-based chemicals as the building blocks in order to promote the sustainability of the heat transfer products. At the same time, the processing method must be applicable to current heat transfer production method and the resultant bio-based heat transfer can maintain comparable performance with TPU garment heat transfer.

### SUMMARY OF THE INVENTION

In accordance with a first aspect of the present invention, there is provided a screen printing formulation for use in processing a heat transfer. The screen printing formulation includes a bio-based pre-polymer resin with an average molecular weight in a range of 8,000 g/mol to 30,000 g/mol, at least one nanofiller, at least one dyestuff, at least one amine, at least one plasticizer, at least one solvent and at least one crosslinker. The bio-based content in the bio-based screen printing formulation is equivalent to the bio-based content in the cured bio-based screen printing formulation.

Preferably, the bio-based pre-polymer resin has an average molecular weight in a range of 10,000-25,000 g/mol.

In an embodiment of the first aspect, the bio-based screen printing formulation has a bio-based content from 0.1% to 93%.

In an embodiment of the first aspect, the bio-based pre-polymer resin is synthesized by polycondensation of one or more diols, di-acids and unsaturated di-acids, or a combination thereof. The unsaturated pre-polymer resin is cured by click crosslinker(s) under atmospheric pressure and below 80° C.

In an embodiment of the first aspect, the at least one nanofiller includes anatase titanium dioxide, rutile titanium dioxide, stearic acid coated titanium dioxide, zinc oxide, silicon dioxide, hydrophilic silicon dioxide, hydrophobic silicon dioxide, silane coated silicon dioxide, zirconium dioxide, alpha aluminum dioxide, alpha superhydrophobic aluminum dioxide, gamma aluminum dioxide, charcoal, talc, mica, or a combination thereof.

In an embodiment of the first aspect, the nanofiller has an average diameter between 1 nm and 80 μm.

In an embodiment of the first aspect, the at least one dyestuff includes anatase titanium dioxide, rutile titanium dioxide, hydrophilic titanium dioxide, hydrophobic titanium dioxide, iron oxides, Heliogen Green K 8730, silicic acid aluminum sodium salt sulfurized, chrome antimony titanium buff rutile, Ultramarine Blue, Yellow L 1061 HD, Yellow L 1100, Orange L 3250 HD, Violet L 5120, Red L 3670 HD, carbon black, pigment powder extracted from plants, or a combination thereof.

In an embodiment of the first aspect, the at least one amine includes methylamine, ethylamine, ethanolamine, propanolamine, diethylamine, trimethylamine, methylene diamine, ethylenediamine, propane-1,3-diamine, diethylene triamine, triethylene tetramine, or a combination thereof.

In an embodiment of the first aspect, the at least one plasticizer includes olive oil, peanut oil, octadecyl acrylate, dodecyl acrylate, or a combination thereof.

In an embodiment of the first aspect, the at least one solvent includes ethanol, propan-1-ol, isopropanol, butan-1-ol, butan-2-ol, pantan-1-ol, pantan-2-ol, pantan-3-ol, pentan-1-one, pentan-2-one, hexan-1-ol, hexan-2-ol, hexan-2-one, hexan-3-one, cyclohexanone, or a combination thereof.

In an embodiment of the first aspect, the at least one crosslinker comprises 1,3-propanedithiol, 1,6-hexanedithiol, trimethylolpropane tris(3-mercaptopropionate, pentaerythritol tetra(3-mercaptopropionate), or a combination thereof.

In an embodiment of the first aspect, the screen printing formulation contains 1-60 wt % of the at least one nanofiller, 0.1-5 wt % of the at least one amine, 1-50 wt % of the at least one dyestuff, 0.1-10 wt % of the at least one plasticizer, and 50-200 wt % of the at least one solvent.

In accordance with a second aspect of the present invention, there is provided a method of preparing said screen printing formulation, including steps of (a) preparing a bio-based pre-polymer resin with an average molecular weight in a range of 8,000 g/mol to 30,000 g/mol; (b) mixing at least one nanofiller, at least one dyestuff, at least one amine, at least one plasticizer and at least one solvent with the bio-based pre-polymer resin to form a screen printing ink with a viscosity of 1,000-60,000 mPa·s at room temperature; and (c) mixing at least one crosslinker with the screen printing ink to obtain the bio-based screen printing formulation.

The pre-polymer resin, nanofiller(s), dyestuff(s), amine(s), plasticizer(s) and solvent(s) are homogenized by a grinder, and they are mixed by magnetic or mechanical stirring.

In an embodiment of the second aspect, the bio-based pre-polymer resin is added just after synthesis when a working temperature is in a range of 80° C.-150° C.

The crosslinker(s) is/are added and mixed just before screen printing process to form a screen printing formulation. The crosslinker(s) is/are mixed by mechanical stirring.

In an embodiment of the second aspect, the bio-based pre-polymer resin is synthesized by polycondensation of diol(s), di-acid(s) and unsaturated di-acid(s) in the presence of at least one stabilizer, a catalyst and an inorganic acid. The diol(s), di-acid(s) and unsaturated di-acid(s) are preferably derived from renewable plant sources, i.e. bio-based chemicals.

In one embodiment of the second aspect, the screen printing formulation contains 1-60 wt % of the at least one nanofiller, 0.1-5 wt % of the at least one amine, 1-50 wt % of the at least one dyestuff, 0.1-10 wt % of the at least one plasticizer, and 50-200 wt % of the at least one solvent.

In an embodiment of the second aspect, the diol(s) includes at least one of ethylene glycol, 1,3-propandiol, propylene glycol, 1,4-butanediol, 1,4-pentanediol, 1,5-pentanediol, 2,5-di(hydroxymethyl)furan, 2,5-dihydroxymethyl tetrahydrofuran, 2-methyl-1,4-butanediol and a mixture thereof, preferably produced through fermentation of plant based raw materials.

In an embodiment of the second aspect, the di-acid(s) includes at least one of sebacic acid, succinic acid, 2,5-furandicarboxylic acid, malic acid, malonic acid, glutaric acid and a mixture thereof, preferably produced through fermentation of plant based raw materials.

In an embodiment of the second aspect, the unsaturated di-acid(s) includes at least one of itaconic acid, fumaric acid and a mixture thereof, preferably produced through fermentation of plant-based raw materials.

In an embodiment of the second aspect, the stabilizer(s) includes at least one bis(2,2,6,6-Tetramethyl-4-Piperidyl) sebacate (BS), bis(1-undecanoxy-2,2,6,6-tetramethylpiperidin-4-yl)carbonate (BC), Tetrakis(1,2,2,6,6-pentamethyl-4-piperidyl) butane-1,2,3,4-tetracarboxylate (TB), (2,2,6,6-tetramethylpiperidin-1-yl)oxyl or (2,2,6,6-tetramethylpiperidin-1-yl)oxidanyl (TEMPO) and a mixture thereof.

In an embodiment of the second aspect, the catalyst includes of titanium butoxide or ethylene glycol antimony.

In an embodiment of the second aspect, the nanofiller(s) includes at least one of anatase titanium dioxide, rutile titanium dioxide, stearic acid coated titanium dioxide, zinc oxide, silicon dioxide, hydrophilic silicon dioxide, hydrophobic silicon dioxide, silane coated silicon dioxide, zirconium dioxide, alpha aluminum dioxide, alpha superhydrophobic aluminum dioxide, gamma aluminum dioxide, charcoal, talc, mica and a mixture thereof.

In an embodiment of the second aspect, the nanofiller(s) have the average diameter between 1 nm and 80 μm.

In an embodiment of the second aspect, the dyestuff(s) includes at least one of anatase titanium dioxide, rutile titanium dioxide, hydrophilic titanium dioxide, hydrophobic titanium dioxide, iron oxides, Heliogen® Green K 8730, silicic acid aluminum sodium salt sulfurized, chrome antimony titanium buff rutile, Ultramarine Blue, Cromophtal® Yellow L 1061 HD, Sicopal® Yellow L 1100, Irgazin® Orange L 3250 HD, Cinquasia® Violet L 5120, Irgazin® Red L 3670 HD, carbon black, pigment powder extracted from plants and a mixture thereof.

In an embodiment of the second aspect, the amine(s) includes at least one of methylamine, ethylamine, ethanolamine, propanolamine, diethylamine, trimethylamine, methylene diamine, ethylenediamine, propane-1,3-diamine, diethylene triamine, triethylene tetramine and a mixture thereof.

In an embodiment of the second aspect, the plasticizer(s) includes at least one of olive oil, peanut oil, octadecyl acrylate, dodecyl acrylate and a mixture thereof.

In an embodiment of the second aspect, the solvent(s) includes at least one of ethanol, propan-1-ol, isopropanol, butan-1-ol, butan-2-ol, pantan-1-ol, pantan-2-ol, pantan-3-ol, pentan-1-one, pentan-2-one, hexan-1-ol, hexan-2-ol, hexan-2-one, hexan-3-one, cyclohexanone and a mixture thereof, preferably produced through fermentation of plant based raw materials.

In an embodiment of the second aspect, the crosslinker(s) includes at least one of 1,3-propanedithiol, 1,6-hexanedithiol, trimethylolpropane tris(3-mercaptopropionate, pentaerythritol tetra(3-mercaptopropionate) and a mixture thereof.

In an embodiment of the second aspect, the bio-based pre-polymer resin is added just after synthesis when a working temperature is in a range of 80° C.-150° C.

In an embodiment of the second aspect, the step of introducing nanofiller(s), dyestuff(s), amine(s), plasticizer(s), solvent(s) into the pre-polymer resin to give screen printing ink further comprising mixing by a mechanical stirrer.

In an embodiment of the second aspect, the step of introducing nanofiller(s), dyestuff(s), amine(s), plasticizer(s), solvent(s) into the pre-polymer resin to give screen printing ink further including homogenization by a grinder.

In an embodiment of the second aspect, the step of introducing crosslinker(s) into the screen printing ink to give the screen printing formulation further including mixing by a mechanical stirrer.

In an embodiment of the second aspect, the step of introducing crosslinker(s) into the screen printing ink to give the screen printing formulation is conducted just before a screen printing process.

In accordance with a third aspect of the present invention, there is provided a method of processing a heat transfer with a screen printing formulation onto a surface of a sheet substrate. The method includes providing said screen printing formulation; printing one or more images by a screen printing method; spraying hot melt adhesive powder onto a last layer of printed images to fully cover the screen printing formulation; drying and curing the screen printing formulation to form a heat transfer laminate on the sheet substrate.

A step of spraying amine solution is optionally conducted after printing image. The amine solution is at least one of methylamine, ethylamine, ethanolamine, diethylamine, trimethylamine, methylene diamine, ethylenediamine, propane-1,3-diamine, diethylene triamine, triethylene tetramine and a mixture thereof dissolved in at least one of ethanol, propanol and a mixture thereof.

In an embodiment of the third aspect, the step of printing the screen printing formulation further comprising single layer or multi-layer printing.

In an embodiment of the third aspect, the multi-layer printing further including step of repeated treating the printed screen printing formulation to form an intermediate laminate layer on the sheet substrate and printing an additional layer of screen printing formulation onto the surface of the previous intermediate laminate layer on the same sheet substrate.

In an embodiment of the third aspect, the hot melt powder includes polyamide, copolyamide, polyester, copolyester, polyurethane, or a combination thereof.

In an embodiment of the third aspect, further including removing the hot melt adhesive powder which are not attached onto the screen printing formulation after the step of spraying the hot melt adhesive powder.

In an embodiment of the third aspect, the treating, drying and curing methods includes at least one of thermal convection, IR, variable frequency microwave (VFM) and a mixture thereof.

### BRIEF DESCRIPTION OF THE DRAWINGS

Embodiments of the invention are described in more details hereinafter with reference to the drawings, in which:

FIGS. 1A-1B schematically show the 2 steps of the polycondensation reaction of diols and di-acids to form a polyester pre-polymer resin;

FIG. 2 schematically depicts the chemical reaction between a typical crosslinker in certain embodiments and the pre-polymer resin by click reaction;

FIG. 3A depicts the appearance with hot melt side facing top while FIG. 3B depicts the appearance with film substrate facing top; and

FIG. 4 depicts the report of bio-based content of the cured screen printing formulation of the present invention. The bio-based content test is determined by a third party testing laboratory.

### DETAILED DESCRIPTION

In the following description, the formulations, compositions and methods for producing and using the same, and the likes, are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The present invention provides a screen printing formulation for use in processing a heat transfer. The screen printing formulation includes a bio-based pre-polymer resin with an average molecular weight in a range of 8,000 g/mol to 30,000 g/mol, at least one nanofiller, at least one dyestuff, at least one amine, at least one plasticizer, at least one solvent and at least one crosslinker. The bio-based content in the bio-based screen printing formulation is equivalent to the bio-based content in the cured bio-based screen printing formulation.

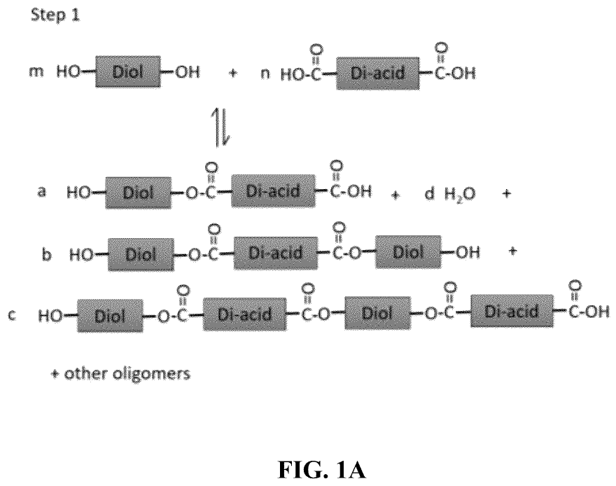

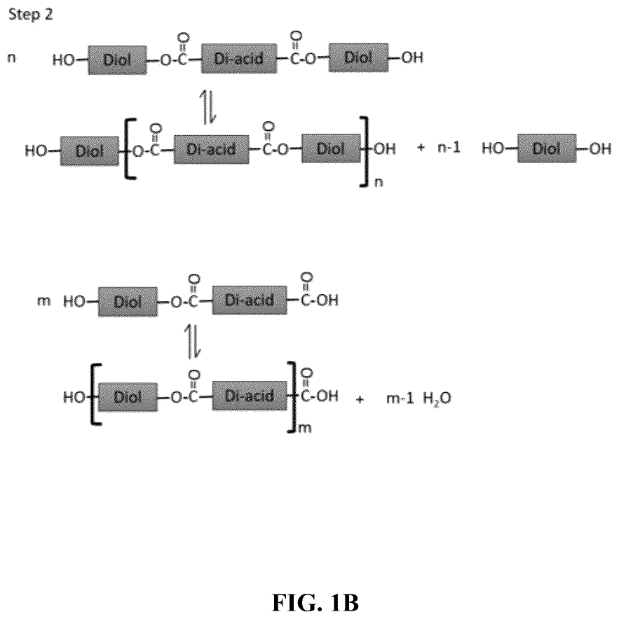

The bio-based pre-polymer resin is synthesized by polycondensation of one or more diols, di-acids and unsaturated di-acids, or a combination thereof. The one or more diols, di-acids and unsaturated di-acids are used for forming polyester by polycondensation. The reaction contains two steps and is illustrated in FIGS. 1A-1B. Referring to FIG. 1A, in the step 1, diols and di-acids are reacted under a lower temperature, such as 180° C., with nitrogen gas purging and stirring to form low molecular weight oligomers. Water molecules are evolved. In the step 2, the temperature is further increased to 200-250° C. and pressure is reduced to below 10 mBar to facilitate removal of by-products, such as water and diols. The by-products are continuously removed by reduced pressure in order to displace the equilibrium in the reaction of higher molecular weights. (FIG. 1B).

In certain embodiments, the unsaturated di-acid is used for providing alkene C═C groups on the polyester chains so that crosslinking can be taken place to form crosslinked polyester when crosslinker(s) is/are added.

In certain embodiments, the bio-based diols and bio-based di-acids, and bio-based unsaturated di-acids are used for promoting sustainability of the heat transfer products by using plants derived chemicals to replace petroleum derived chemicals.

The diol(s) may include at least one of ethylene glycol, 1,3-propandiol, propylene glycol, 1,4-butanediol, 1,4-pentanediol, 1,5-pentanediol, 2,5-di(hydroxymethyl)furan, 2,5-dihydroxymethyl tetrahydrofuran, 2-methyl-1,4-butanediol and a mixture thereof, preferably produced through fermentation of plant based raw materials.

The di-acid(s) may include at least one of sebacic acid, succinic acid, 2,5-furandicarboxylic acid, malic acid, malonic acid, glutaric acid and a mixture thereof, preferably produced through fermentation of plant based raw materials.

The unsaturated di-acid(s) may include at least one of itaconic acid, fumaric acid and a mixture thereof, preferably produced through fermentation of plant-based raw materials.

In certain embodiments, the stabilizer(s) is/are used for protecting the C═C groups of the unsaturated di-acid by capturing free radicals, if any, formed during polycondensation reaction under high temperature. Therefore, the C═C groups in the pre-polymer resin can be retained and used for crosslinking in the curing process. Traditional phenolic type stabilizers, such as hydroquinone and 4-methoxyphenol, cause serious browning to the resultant pre-polymer resin, probably because of the formation of polyphenols. In addition, traditional phenolic stabilizers also have chemical safety risk and they are one kind of restricted substances under Registration, Evaluation, Authorization and Restriction of Chemicals (REACH). The stabilizers in certain embodiments are non-phenolic antioxidant, classified as hindered amine light stabilizer (NALS). They contain amine functional groups for removing free radicals and are chemically safe.

In certain embodiments, the catalyst is used for catalyzing the polycondensation reaction that the reaction can take place with a shorter time and the resultant molecule weight of the polyester can be larger. The catalyst may include titanium butoxide or ethylene glycol antimony.

In certain embodiments, the nanofiller(s) is/are used for enhancing mechanical strength of the heat transfer by interacting with the pre-polymer resin. They are also used for promoting surface appearance of the printed heat transfer. They promote the compatibility of the screen printing formulation with the sheet substrate to give smooth and even surface without pin hole of the printed images and facilitate releasing of the heat transfer from the sheet substrate.

In certain embodiments, the dyestuff(s) is/are used for giving desired color to the printed images of the heat transfers. The dyestuff(s) may include anatase titanium dioxide, rutile titanium dioxide, hydrophilic titanium dioxide.

In certain embodiments, the amine(s) and amine solution are used for controlling the crosslinking rate by adjusting pH value of the heat transfer formulation. The amine(s) may include methylamine, ethylamine, ethanolamine, propanolamine, diethylamine, trimethylamine, methylene diamine, ethylenediamine, propane-1,3-diamine, diethylene triamine, triethylene tetramine, or a combination thereof. The amine solution may include methylamine, ethylamine, ethanolamine, diethylamine, trimethylamine, methylene diamine, ethylenediamine, propane-1,3-diamine, diethylene triamine, triethylene tetramine and a mixture thereof dissolved in at least one of ethanol, propanol and a mixture thereof.

In certain embodiments, the plasticizer(s) is/are used to prevent cracking after long term storage of the heat transfer products. The plasticizer may include olive oil, peanut oil, octadecyl acrylate, dodecyl acrylate, or a combination thereof.

In certain embodiments, the solvent(s) is/are used for adjusting the viscosity of the screen printing formulation so as to maximize the printing time and number of sheets can be printed before the screen is blocked while the image quality of the heat transfer is maintained. These solvent may include ethanol, propan-1-ol, isopropanol, butan-1-ol, butan-2-ol, pantan-1-ol, pantan-2-ol, pantan-3-ol, pentan-1-one, pentan-2-one, hexan-1-ol, hexan-2-ol, hexan-2-one, hexan-3-one, cyclohexanone, or a combination thereof.

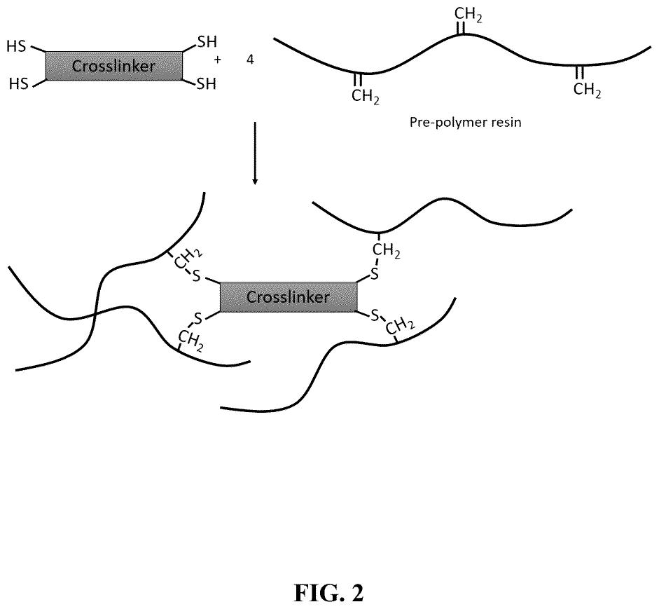

In certain embodiments, the crosslinker(s) is/are used for crosslinking the C═C groups on the polyester chains by click reaction to form crosslinked polyester. Each of the crosslinker molecule contains more than one thiol S—H groups, which can react with C═C groups by thiol-ene click reaction to form stable and irreversible thioether linkages between/among polyester chains. FIG. 2 illustrates the chemical reaction between the crosslinkers and the C═C groups of the pre-polymer resin. The traditional vulcanization agents, such as dioxide and sulfur, require high processing temperature of 130° C. or above with compressive pressure, which is not applicable to heat transfer production process. Instead of vulcanization agents, the crosslinker(s) used in the present invention, called click crosslinker(s), is/are able to crosslink the pre-polymer resin under mild temperature below 80° C. without compressive pressure.

In certain embodiments, the VFM is used for providing energy for drying and curing of the screen printing formulation. The frequency of the microwave sweeps between 5.85-6.65 GHz with the sweep time between 0.1-3.0 seconds. The temperature of the sample is monitored by an IR sensor or a fiber optic sensor while the power is set between 0-200 W to control temperature profile so that the sample can be treated with constant temperature by automatic power control.

In another aspect, the present invention provides a method of preparing said screen printing formulation, including steps of (a) preparing a bio-based pre-polymer resin with an average molecular weight in a range of 8,000 g/mol to 30,000 g/mol; (b) mixing at least one nanofiller, at least one dyestuff, at least one amine, at least one plasticizer and at least one solvent with the bio-based pre-polymer resin to form a screen printing ink with a viscosity of 1,000-60,000 mPa·s at room temperature; and (c) mixing at least one crosslinker with the screen printing ink to obtain the bio-based screen printing formulation.

The pre-polymer resin, nanofiller(s), dyestuff(s), amine(s), plasticizer(s) and solvent(s) are homogenized by a grinder, and they are mixed by magnetic or mechanical stirring.

In an embodiment of the second aspect, the bio-based pre-polymer resin is added just after synthesis when a working temperature is in a range of 80° C.-150° C.

The crosslinker(s) is/are added and mixed just before screen printing process to form a screen printing formulation. The crosslinker(s) is/are mixed by mechanical stirring.

In an embodiment of the second aspect, the step of introducing nanofiller(s), dyestuff(s), amine(s), plasticizer(s), solvent(s) into the pre-polymer resin to give screen printing ink further comprising mixing by a mechanical stirrer.

In an embodiment of the second aspect, the step of introducing nanofiller(s), dyestuff(s), amine(s), plasticizer(s), solvent(s) into the pre-polymer resin to give screen printing ink further including homogenization by a grinder.

In an embodiment of the second aspect, the step of introducing crosslinker(s) into the screen printing ink to give the screen printing formulation further including mixing by a mechanical stirrer.

In an embodiment of the second aspect, the step of introducing crosslinker(s) into the screen printing ink to give the screen printing formulation is conducted just before a screen printing process.

In yet another aspect, the present invention provides a a method of processing a heat transfer with a screen printing formulation onto a surface of a sheet substrate. The method includes providing said screen printing formulation; printing one or more images by a screen printing method; spraying hot melt adhesive powder onto a last layer of printed images to fully cover the screen printing formulation; drying and curing the screen printing formulation to form a heat transfer laminate on the sheet substrate.

A step of spraying amine solution is optionally conducted after printing image. The amine solution is at least one of methylamine, ethylamine, ethanolamine, diethylamine, trimethylamine, methylene diamine, ethylenediamine, propane-1,3-diamine, diethylene triamine, triethylene tetramine and a mixture thereof dissolved in at least one of ethanol, propanol and a mixture thereof.

In an embodiment of the third aspect, the step of printing the screen printing formulation further comprising single layer or multi-layer printing.

In an embodiment of the third aspect, the multi-layer printing further including step of repeated treating the printed screen printing formulation to form an intermediate laminate layer on the sheet substrate and printing an additional layer of screen printing formulation onto the surface of the previous intermediate laminate layer on the same sheet substrate.

In an embodiment of the third aspect, the hot melt powder includes polyamide, copolyamide, polyester, copolyester, polyurethane, or a combination thereof.

In an embodiment of the third aspect, further including removing the hot melt adhesive powder which are not attached onto the screen printing formulation after the step of spraying the hot melt adhesive powder.

In an embodiment of the third aspect, the treating, drying and curing methods includes at least one of thermal convection, IR, variable frequency microwave (VFM) and a mixture thereof.

### EXAMPLE

### Example 1—Preparation of the Screen Printing Formulation

The procedures for preparing the screen printing formulation and processing the heat transfer using the screen printing formulation of a specific embodiment were explained as follow:

### Synthesis of Pre-Polymer Resin

All chemicals were used directly without any pre-treatment. The diols, di-acids and unsaturated di-acids were placed in a round bottom flask or a reactor. The mole ratio of diol-to-di-acid was between 1.0-1.5:1 and the unsaturated di-acid was 5-40 wt % of total di-acids. 0.01-0.8 wt % of stabilizer(s) was added to protect the unsaturated C═C groups. With nitrogen gas purging, the temperature was increased to 180° C. and the solids were molten to form homogeneous mixture with magnetic or mechanical stirring. The reactants were reacted at 180° C. with nitrogen gas purging and stirring for 2 hours. After that, 0.05-0.5 wt. % of catalyst and 0.05-0.5 wt % of inorganic acid were added. The inorganic acid was used together with the catalyst for catalyzing the polycondensation reaction. The inorganic acid included phosphoric acid, nitric acid or sulfuric acid.

Then, nitrogen gas purging was removed and the pressure was reduced to 10 mBar or below with continuous stirring. The temperature was increased to 200-240° C. and the reactants were further reacted for 1-8 hours to form the pre-polymer resin. The molecular mass of the pre-polymer resin was determined by gel permeation chromatography (GPC) with tetrahydrofuran (THF) as solvent and polystyrene standards. The number average molecular weight (Mₙ) was between 8,000-40,000 g/mol.

### Preparation of Screen Printing Ink

After synthesis, the pre-polymer resin was cooled down to 60-180° C. The hot pre-polymer resin was poured into the container of a mechanical mixer. 1-60 wt % nanofiller(s), 0.01-5 wt % amine, 1-50 wt % dyestuff(s), 0.01-10% plasticizer(s) and 50-200 wt % solvent(s) relative to the pre-polymer resin were added and mixed. The mixture was further homogenized by passing through a grinder to form the screen printing ink. The viscosity of the screen printing ink was between 1,000-40,000 mPa·s.

The crosslinker must be added to the screen printing ink just before printing. 2-20 wt % crosslinker(s) relative to pre-polymer resin was added to the screening printing ink. The mixture was mechanical stirred to form the screen printing formulation, which was ready for screen printing. The screen printing formulation was poured onto a screen and a screen printing process was started.

After printing an image onto a surface of a sheet substrate using the screen printing formulation, the sheet substrate was optionally sprayed with 0.1-10% amine solution. The printed image was placed in a thermal convection oven, IR oven or VFM oven for drying and curing. The drying and curing temperature was between 20 to 80° C. The drying and curing time was between 10 min to 8 hours.

Screen printing process and drying/curing process could be repeated on the same sheet substrate with the same ingredients or different ingredients of screen printing formulation in order to produce multi-layer heat transfer laminate.

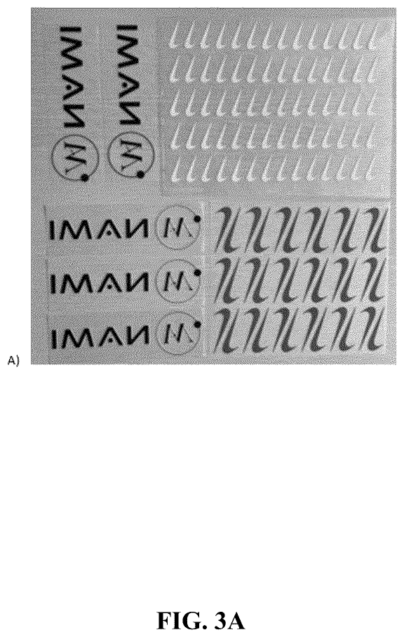

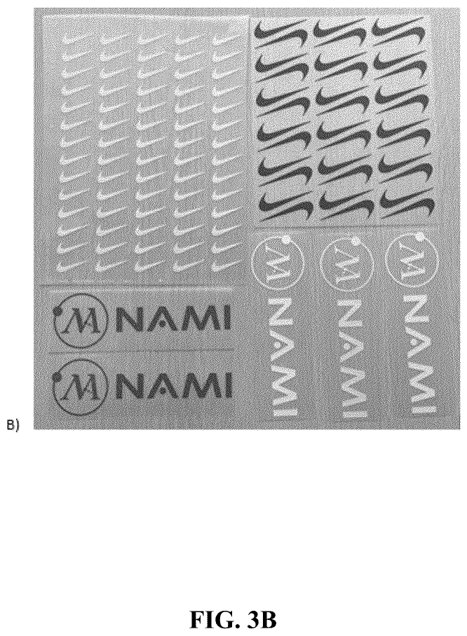

For the final layer, a layer of the screen printing formulation was printed to over all the image area of the sheet substrate. A hot melt adhesive powder was sprayed onto the surface of the sheet substrate. The excessive hot melt adhesive powder, which could not be attached on the image surface, was removed. The sheet substrate was placed in a thermal convection oven, IR oven or VFM oven for drying and curing. The drying and curing temperature was between 60 to 100° C. The drying and curing time was between 1-12 hours. The appearance of some typical heat transfer produced was shown in FIGS. 3A-3B.

### Example 2

### Lab Scale Preparation of Pre-Polymer Resin

All chemicals were used directly without any pre-treatment. 50.2 g 1,3-propanediol, 59.5 g 1,4-butanediol, 149 g sebacic acid, 9.7 g succinic acid, 41.6 g itaconic acid and 0.65 g BS were placed in a 1 L one-neck-round bottom flask. With nitrogen gas purging, the temperature was increased to 180° C. and the solids were molten to form homogeneous mixture with magnetic stirring. The reactants were reacted at 180° C. with nitrogen gas purging and stirring for 2 hours. After that, 0.78 g of titanium butoxide and 0.4 g of phosphoric acid were added. Then, nitrogen gas purging was removed and the pressure was reduced to 1 mBar with continuous stirring. The temperature was increased to 220° C. and the reactants were further reacted for 3-5 hours to form the pre-polymer resin. The molecular mass of the pre-polymer resin was determined by gel permeation chromatography (GPC) with tetrahydrofuran (THF) as solvent and polystyrene standards. The number average molecular weight (Mₙ) was 14,400-35,900 g/mol.

### Example 3

### Pilot Scale Preparation of Bio-Based Pre-Polymer Resin

All chemicals were used directly without any pre-treatment. 753 g bio-based 1,3-propanediol, 892 g bio-based 1,4-butanediol, 2239 g bio-based sebacic acid, 145 g bio-based succinic acid, 625 g bio-based itaconic acid and 1.2 g BS were placed in a 10 L double layer glass reactor with circulation of heating oil. With nitrogen gas purging, the temperature was increased to 180° C. and the solids were molten to form homogeneous mixture with mechanical stirring. The reactants were reacted at 180° C. with nitrogen gas purging and stirring for 2 hours. After that, 11.6 g of titanium butoxide and 5.5 g of phosphoric acid were added. Then, nitrogen gas purging was removed and the pressure is reduced to 1 mBar with continuous stirring. The temperature was increased to 220° C. and the reactants were further reacted for 3-6 hours to form the pre-polymer resin. The molecular mass of the pre-polymer resin was determined by gel permeation chromatography (GPC) with tetrahydrofuran (THF) as solvent and polystyrene standards. The number average molecular weight (Mₙ) was 6,500-23,300 g/mol.

### Example 4

### Pilot Scale Preparation of Bio-Based Pre-Polymer Resin

All chemicals were used directly without any pre-treatment. 4.52 kg bio-based 1,3-propanediol, 5.4 kg bio-based 1,4-butanediol, 13.4 kg bio-based sebacic acid, 870 g bio-based succinic acid, 3.7 kg bio-based itaconic acid and 73 g BS were placed in a 50 L double layered stainless steel reactor with circulation of heating oil. With nitrogen gas purging, the temperature was increased to 180° C. and the solids were molten to form homogeneous mixture with mechanical stirring. The reactants were reacted at 180° C. with nitrogen gas purging and stirring for 2 hours. After that, 70 g of titanium butoxide and 17 g of phosphoric acid were added. Then, nitrogen gas purging was removed and the pressure was reduced to 1 mBar with continuous stirring. The temperature was increased to 230° C. and the reactants were further reacted for 3-6 hours to form the pre-polymer resin. The molecular mass of the pre-polymer resin was determined by gel permeation chromatography (GPC) with tetrahydrofuran (THF) as solvent and polystyrene standards. The number average molecular weight (Mₙ) was within 8,000-23,00 g/mol. The melt flow rate at 50° C. was within 10-80 g/10 min.

### Example 5

### Lab Scale Preparation of Transparent Screen Printing Formulation

After synthesis, the pre-polymer resin was cooled down to around 150° C. 200 g hot pre-polymer resin was poured into a glass container. 40 g of 50 nm silicon dioxide, 1.6 g amine, 66 g ethanol and 33 g propan-1-ol were added and mixed by an overhead mechanical stirrer. The mixture was further homogenized by passing through a grinder to form the screen printing ink. The viscosity of the screen printing ink was between 10,000-20,000 mPa·s.

The crosslinker was added to the screen printing ink just before printing. 18.2 g pentaerythritol tetra(3-mercaptopropionate) was added to the screening printing ink. The mixture was stirred mechanically to form the screen printing formulation, which was ready for screen printing. The screen printing formulation was poured onto a screen and a screen printing process was started. The image-printed sheet substrates were placed in 80° C. thermal convection oven for drying and curing. The curing time was 2.5 hours.

Dogbone shape tensile bars were prepared according to ASTM D638-V using the transparent screen printing formulation. Tensile properties of the cured samples were measured according to ASTM D638-14. The average value of tensile strength and elongation at break were 3.19±0.29 MPa and 466±5%, respectively.

### Example 6

### Lab Scale Preparation of Blue Bio-Based Screen Printing Formulation

After synthesis, the bio-based pre-polymer resin was cooled down to around 150° C. 200 g hot bio-based pre-polymer resin was poured into a glass container. 30 g of 50 nm silicon dioxide, 10 g of 200 nm titanium dioxide, 20 g silicic acid aluminum sodium salt sulfurized, 2.0 g amine, 135 g 1-butanol were added and mixed by an overhead mechanical stirrer. The mixture was further homogenized by passing through a grinder to form the screen printing ink. The viscosity of the screen printing ink was between 10,000-25,000 mPa·s.

The crosslinker was added to the screen printing ink just before printing. 12.8 g pentaerythritol tetra(3-mercaptopropionate) was added to the screening printing ink. The mixture was stirred mechanically to form the screen printing formulation, which was ready for screen printing. The screen printing formulation was poured onto a screen and a screen printing process is started. The image-printed sheet substrates were placed in 80° C. thermal convection oven for drying and curing. The curing time was 1.5 hours.

Dog bone shape tensile bars were prepared according to ASTM D638-V using the transparent screen printing formulation. Tensile properties of the cured samples were measured according to ASTM D638-14. The average value of tensile strength and elongation at break were 2.49±0.25 MPa and 629±48%, respectively.

### Example 7

### Pilot Scale Preparation of Bio-Based White Screen Printing Formulation

After synthesis, the bio-based pre-polymer resin was cooled down to around 140° C. 4.0 kg hot bio-based pre-polymer resin was poured into a stainless steel container. 600 g of 50 nm silicon dioxide, 600 g of 25 nm hydrophilic titanium dioxide, 600 g of 200 nm titanium dioxide, 2.47 kg 1-butanol and 0.53 kg cyclohexanone were added and mixed by an overhead mechanical mixer. The mixture was further homogenized by passing through a grinder to form the screen printing ink. The viscosity of the screen printing ink was between 5,000-15,000 mPa·s.

The crosslinker was added to the screen printing ink just before printing. 205 g pentaerythritol tetra(3-mercaptopropionate) was added to the screening printing ink. The mixture was stirred mechanically to form the screen printing formulation, which was ready for screen printing. The screen printing formulation was poured onto a screen and a screen printing process was started. The image-printed sheet substrates were sprayed with a layer of 5% amine solution. After that, the image-printed sheet substrates was stayed at room temperature for 0.5 h followed by placing in a 70° C. IR oven for drying and curing. The curing time was 0.5 h.

Dogbone shape tensile bars were prepared according to ASTM D638-V using the transparent screen printing formulation. Tensile properties of the cured samples were measured according to ASTM D638-14. The average value of tensile strength and elongation at break were 2.99±0.62 MPa and 773±180%, respectively.

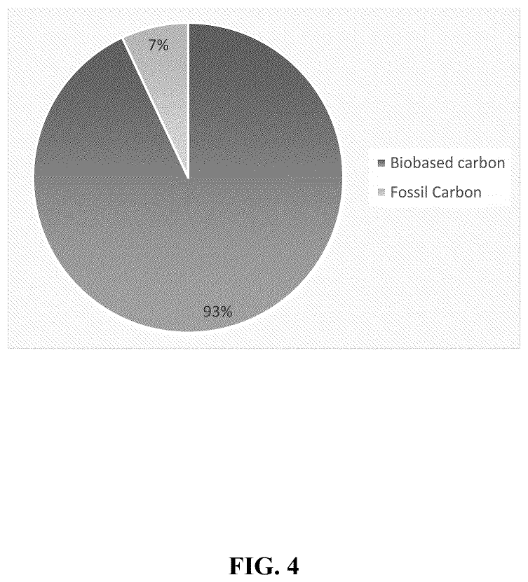

The bio-based content of the cured screen printing formulation was measured according to ASTM D6866 conducted by a third party testing laboratory. The bio-based content was 93% and the testing report was shown in FIG. 4.

### Example 8

### Pilot Scale Preparation of Yellow Screen Printing Formulation

After synthesis, the pre-polymer resin was cooled down to around 140° C. 2.0 kg hot pre-polymer resin was poured into a stainless steel container. 300 g of 50 nm silicon dioxide, 100 g of 200 nm titanium dioxide, 200 g chrome antimony titanium buff rutile, 16 g amine, 210 g 1-butanol and 410 g cyclohexanone were added and mixed by an overhead mechanical mixer. The mixture was further homogenized by passing through a grinder to form the screen printing ink. The viscosity of the screen printing ink was between 10,000-25,000 mPa·s.

The crosslinker was added to the screen printing ink just before printing. 128 g pentaerythritol tetra(3-mercaptopropionate) was added to the screening printing ink. The mixture was stirred mechanically to form the screen printing formulation, which was ready for screen printing. The screen printing formulation was poured onto a screen and a screen printing process was started. The image-printed sheet substrates were placed in 80° C. IR oven for drying and curing. The curing time was 3 hours.

Dogbone shape tensile bars were prepared according to ASTM D638-V using the transparent screen printing formulation. Tensile properties of the cured samples were measured according to ASTM D638-14. The average value of tensile strength and elongation at break were 2.49±0.69 MPa and 552±43%, respectively.

### Example 9

### Pilot Scale Preparation of Bio-Based Anti-Migration Screen Printing Formulation

After synthesis, the bio-based pre-polymer resin was cooled down to around 140° C. 3.0 kg hot bio-based pre-polymer resin was poured into a stainless steel container. 1.5 kg of charcoal, 150 g of plasticizer, 2.25 kg 1-butanol and 0.85 kg cyclohexanone were added and mixed by an overhead mechanical mixer. The mixture was further homogenized by passing through a grinder to form the screen printing ink. The viscosity of the screen printing ink was between 4,000-15,000 mPa·s.

The crosslinker was added to the screen printing ink just before printing. 205 g pentaerythritol tetra(3-mercaptopropionate) was added to the screening printing ink. The mixture was stirred mechanically to form the screen printing formulation, which was ready for screen printing. The screen printing formulation was poured onto a screen and a screen printing process was started. The image-printed sheet substrates were sprayed with a layer of 5% amine solution. After that, the image-printed sheet substrates was stayed at room temperature for 0.5 h followed by placing in a 70° C. IR oven for drying and curing. The curing time was 0.5 h.

Dogbone shape tensile bars were prepared according to ASTM D638-V using the transparent screen printing formulation. Tensile properties of the cured samples were measured according to ASTM D638-14. The average value of tensile strength and elongation at break were 4.57±0.31 MPa and 238±17%, respectively.

### Comparative Example 1

A water-based white PU screen printing formulation was poured onto a screen and a screen printing process was started. The image-printed sheet substrates were placed in a 60° C. IR oven for drying and curing. The curing time was 1.5 hours.

Dogbone shape tensile bars were prepared according to ASTM D638-V using the water-based white PU screen printing formulation. Tensile properties of the cured samples were measured according to ASTM D638-14. The average value of tensile strength and elongation at break were 1.36±0.37 MPa and 1280±160%, respectively.

### Example 10

### Production of Multi-Layer Heat Transfer Product and Quality Tests

A multi-layer heat transfer product was prepared using the bio-based heat transfer formulation with various color and compositions. The first 2 layers were printed with blue formulation with composition and processing same as Example 4. The 3^{rd} and 4^{th} layers were printed with white formulation with composition and processing same as Example 5. The 5^{th} and 6^{th} layers were printed with anti-migration formulation with composition and processing same as Example 7. The 7^{th} and 8^{th} layers were printed with transparent formulation with composition and processing same as Example 3. Before processing the 8^{th} layer, a polyester type hot melt adhesive powder was sprayed onto the surface of the sheet substrate. The excessive hot melt adhesive powder, which could not be attached on the image surface, was removed.

The cured heat transfer was then applied on a piece of black fabric. Firstly, the fabric was placed on the processing stage of a garment hot press machine. A piece of the cured heat transfer, whose hot melt side faces the fabric, was placed on top of the fabric. A temperature of 150° C. and compressive pressure were applied onto the heat transfer and fabric for 20 seconds in order to allow melting of the hot melt adhesive powder. After that, the pressure was release and the fabric together with the heat transfer is removed and was cooled down. The sheet substrate was teared off and the image was transferred to the fabric firmly.

The image attached fabrics were underwent a washing test according to a garment laundry standard. Typically, at least 20 pieces of the same image attached fabrics were washed together with a domestic washing machine to wash at 60° C. of normal cycle followed by low temperature tumble dry. The washing and tumble drying cycle were repeated for 10 times. After that, the image attached fabrics were inspected if there was peel off, cracking, shrinkage, wrinkle and color migration of the heat transfer images. All 20 pieces of image attached fabrics had to be without peel off, cracking, shrinkage, wrinkle and color migration of the heat transfer images in order to pass the washing test. The heat transfer images produced with present invention were able to pass the washing test.

The image attached fabrics were underwent a stretching test according to a garment stretching standard. The image attached fabrics were pulled at the horizontal direction, vertical direction and diagonal direction, respectively, for 3 times manually. The image attached fabrics were inspected if there is cracking. The heat transfer images produced with present invention were able to pass the stretching test without cracking.

The present invention could be cured under similar conditions of the water-based PU screen printing formulation, i.e. 80° C. without compressive pressure. In addition, the present invention showed obviously higher tensile strength comparing with the water-based PU screen printing formulation. Although the elongation of the present invention was smaller, it was sufficient to meet the quality standards of heat transfer, which only required having 100% elongation, for example, a 10 cm image could be pulled to 20 cm without breaking.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

### Definition

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. The term “substantially coplanar” may refer to two surfaces within a few micrometers (μm) positioned along the same plane, for example, within 10 μm, within 5 μm, within 1 μm, or within 0.5 μm located along the same plane. When reference is made to “substantially” the same numerical value or characteristic, the term may refer to a value within ±10%, ±5%, ±1%, or ±0.5% of the average of the values.

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

### INDUSTRIAL APPLICABILITY

The present invention of bio-based screen printing formulation for processing a heat transfer significantly promotes renewable content of the heat transfer product by replacing petroleum-based chemicals with bio-based chemicals. The bio-based screen printing formulation is applicable to current printing and processing methods of garment heat transfer. The heat transfer produced by the bio-based screen printing formulation shows enhanced tensile strength. Its elongation and durability are sufficient to meet quality standards of garment heat transfer.

What is claimed is:

1. A bio-based screen printing formulation for processing a heat transfer, comprising a bio-based pre-polymer resin with an average molecular weight in a range of 8,000 g/mol to 30,000 g/mol, at least one nanofiller, at least one dyestuff, at least one amine, at least one plasticizer, at least one solvent and at least one crosslinker, wherein the bio-based screen printing formulation has a bio-based content from 0.1% to 93%.

2. The bio-based screen printing formulation of claim 1, wherein the bio-based pre-polymer resin is synthesized by polycondensation of one or more diols, di-acids and unsaturated di-acids, or a combination thereof.

3. The bio-based screen printing formulation of claim 1, wherein the at least one nanofiller comprises anatase titanium dioxide, rutile titanium dioxide, stearic acid coated titanium dioxide, zinc oxide, silicon dioxide, hydrophilic silicon dioxide, hydrophobic silicon dioxide, silane coated silicon dioxide, zirconium dioxide, alpha aluminum dioxide, alpha superhydrophobic aluminum dioxide, gamma aluminum dioxide, charcoal, talc, mica, or a combination thereof.

4. The bio-based screen printing formulation of claim 1, wherein the at least one dyestuff comprises anatase titanium dioxide, rutile titanium dioxide, hydrophilic titanium dioxide, hydrophobic titanium dioxide, iron oxides, Heliogen Green K 8730, silicic acid aluminum sodium salt sulfurized, chrome antimony titanium buff rutile, Ultramarine Blue, Yellow L 1061 HD, Yellow L 1100, Orange L 3250 HD, Violet L 5120, Red L 3670 HD, carbon black, pigment powder extracted from plants, or a combination thereof.

5. The bio-based screen printing formulation of claim 1, wherein the at least one amine comprises methylamine, ethylamine, ethanolamine, propanolamine, diethylamine, trimethylamine, methylene diamine, ethylenediamine, propane-1,3-diamine, diethylene triamine, triethylene tetramine, or a combination thereof.

6. The bio-based screen printing formulation of claim 1, wherein the at least one plasticizer comprises olive oil, peanut oil, octadecyl acrylate, dodecyl acrylate, or a combination thereof.

7. The bio-based screen printing formulation of claim 1, wherein the at least one solvent comprises ethanol, propan-1-ol, isopropanol, butan-1-ol, butan-2-ol, pantan-1-ol, pantan-2-ol, pantan-3-ol, pentan-1-one, pentan-2-one, hexan-1-ol, hexan-2-ol, hexan-2-one, hexan-3-one, cyclohexanone, or a combination thereof.

8. The bio-based screen printing formulation of claim 1, wherein the at least one crosslinker comprises 1,3-propanedithiol, 1,6-hexanedithiol, trimethylolpropane tris(3-mercaptopropionate, pentaerythritol tetra(3-mercaptopropionate), or a combination thereof.

9. The bio-based screen printing formulation of claim 1, comprising:
1-60 wt % of the at least one nanofiller;
0.1-5 wt % of the at least one amine;
1-50 wt % of the at least one dyestuff;
0.1-10 wt % of the at least one plasticizer; and
50-200 wt % of the at least one solvent.

10. A method for preparing a bio-based screen printing formulation for processing a heat transfer, comprising:
preparing a bio-based pre-polymer resin with an average molecular weight in a range of 8,000 g/mol to 30,000 g/mol;
mixing at least one nanofiller, at least one dyestuff, at least one amine, at least one plasticizer and at least one solvent with the bio-based pre-polymer resin to form a screen printing ink with a viscosity of 1,000-60,000 mPa·s at room temperature, and wherein the bio-based pre-polymer resin is added just after synthesis when a working temperature is in a range of 80° C.-150° C.; and
mixing at least one crosslinker with the screen printing ink to obtain a bio-based screen printing formulation.

11. The method according to claim 10, wherein the pre-polymer resin is synthesized by polycondensation of diol(s), di-acid(s) and unsaturated di-acid(s) in the presence of at least one stabilizer, a catalyst and an inorganic acid.

12. The method according to claim 10, wherein the bio-based screen printing formulation comprises:
1-60 wt % of the at least one nanofiller;
0.1-5 wt % of the at least one amine;
1-50 wt % of the at least one dyestuff;
0.1-10 wt % of the at least one plasticizer; and
50-200 wt % of the at least one solvent.

13. The method according to claim 11, wherein the diol(s) comprise ethylene glycol, 1,3-propandiol, propylene glycol, 1,4-butanediol, 1,4-pentanediol, 1,5-pentanediol, 2,5-di(hydroxymethyl)furan, 2,5-dihydroxymethyl tetrahydrofuran, 2-methyl-1,4-butanediol and a mixture thereof; the di-acids(s) comprise at least one of sebacic acid, succinic acid, 2,5-furandicarboxylic acid, malic acid, malonic acid, glutaric acid and a mixture thereof; the unsaturated di-acids(s) comprise at least one of itaconic acid, fumaric acid and a mixture thereof; and the inorganic acid comprises phosphoric acid, nitric acid or sulfuric acid.

14. The method according to claim 11, wherein the at least one stabilizer comprises bis(2,2,6,6-Tetramethyl-4-Piperidyl) sebacate (BS), bis(1-undecanoxy-2,2,6,6-tetramethylpiperidin-4-yl)carbonate (BC), tetrakis(1,2,2,6,6-pentamethyl-4-piperidyl) butane-1,2,3,4-tetracarboxylate (TB), (2,2,6,6-tetramethylpiperidin-1-yl)oxyl or (2,2,6,6-tetramethylpiperidin-1-yl)oxidanyl (TEMPO) and a mixture thereof; and the catalyst comprises titanium butoxide or ethylene glycol antimony.

15. The method according to claim 10, wherein the at least one nanofiller comprises anatase titanium dioxide, rutile titanium dioxide, stearic acid coated titanium dioxide, zinc oxide, silicon dioxide, hydrophilic silicon dioxide, hydrophobic silicon dioxide, silane coated silicon dioxide, zirconium dioxide, alpha aluminum dioxide, alpha superhydrophobic aluminum dioxide, gamma aluminum dioxide, charcoal, talc, mica, or a combination thereof.

16. The method according to claim 10, wherein the at least one dyestuff comprises anatase titanium dioxide, rutile titanium dioxide, hydrophilic titanium dioxide, hydrophobic titanium dioxide, iron oxides, Heliogen Green K 8730, silicic acid aluminum sodium salt sulfurized, chrome antimony titanium buff rutile, Ultramarine Blue, Yellow L 1061 HD, Yellow L 1100, Orange L 3250 HD, Violet L 5120, Red L 3670 HD, carbon black, pigment powder extracted from plants, or a combination thereof.

17. The method according to claim 10, wherein the at least one amine comprises methylamine, ethylamine, ethanolamine, propanolamine, diethylamine, trimethylamine, methylene diamine, ethylenediamine, propane-1,3-diamine, diethylene triamine, triethylene tetramine, or a combination thereof.

18. The method according to claim 10, wherein the at least one plasticizer comprises olive oil, peanut oil, octadecyl acrylate, dodecyl acrylate, or a combination thereof.

19. The method according to claim 10, wherein the at least one solvent comprises ethanol, propan-1-ol, isopropanol, butan-1-ol, butan-2-ol, pantan-1-ol, pantan-2-ol, pantan-3-ol, pentan-1-one, pentan-2-one, hexan-1-ol, hexan-2-ol, hexan-2-one, hexan-3-one, cyclohexanone, or a combination thereof.

20. The method according to claim 10, wherein the at least one crosslinker comprises 1,3-propanedithiol, 1,6-hexanedithiol, trimethylolpropane tris(3-mercaptopropionate, pentaerythritol tetra(3-mercaptopropionate), or a combination thereof.
